(19) United States
(12) Patent Application Publication
(10) Pub. No.: US 2007/0237117 A1
(43) Pub. Date: Oct. 11, 2007

(54) Apparatus and method for transmitting message in a mobile communication system

(75) Inventors: Hi-Chan Moon, Yongin-si (KR); Seung-Chul Hong, Hwaseong-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/726,355

(22) Filed: Mar. 21, 2007

(30) Foreign Application Priority Data
Mar. 21, 2006 (KR) 25892-2006

(51) Int. Cl. H04B 7/216

(52) U.S. Cl. 370/335

(57) ABSTRACT

An apparatus and method for transmitting a message in a mobile communication system are provided, in which a short message is generated to be sent together with a preamble signal on the RACH, for uplink transmission, the short message and the preamble signal are spread with different orthogonal spreading codes, the phase of the short message is rotated to be orthogonal to the phase of the preamble signal, the phase-rotated short message is added to the preamble signal, and the sum is sent.

### PRIORITY

This application claims priority under 35 U.S.C. §119(a) to a Korean Patent Application filed in the Korean Intellectual Property Office on Mar. 21, 2006 entitled “Apparatus and Method for Transmitting Message in a Mobile Communication System” and assigned Serial No. 2006-25892, the entire disclosure of which is incorporated herein by reference.

### BACKGROUND OF THE INVENTION

1. Field of the Invention

The present invention generally relates to an apparatus and method for transmitting a message in a mobile communication system. More particularly, the present invention relates to an apparatus and method for transmitting an uplink message in a mobile communication system.

2. Description of the Related Art

Typically, mobile communication systems are designed to provide communication services to users irrespective of their locations. These mobile communication systems have downlink (forward) channels and uplink (reverse) channels to provide bidirectional communication services. Downlink is the direction from a Base Station (BS) to a Mobile Station (MS), and uplink is the direction from the MS to the BS.

The mobile communication systems operate synchronously or asynchronously. In an asynchronous Wideband Code Division Multiple Access (WCDMA) or Universal Mobile Telecommunication System (UMTS) considered as one of future-generation mobile communication systems, the uplink common channel called Random Access Channel (RACH) is used for communications.

FIG. 1 is a diagram illustrating the transmission and reception timings of a downlink channel and an uplink common channel in a conventional asynchronous communication system.

Referring to FIG. 1, reference numeral 151 denotes an uplink channel, for example, an RACH and reference numeral 101 denotes a downlink channel called Access Preamble-Acquisition Indication Channel (AP-AICH). For a signal received on RACH 151, a response signal is sent on AP-AICH 101.

An MS sends an initial preamble 152 of a predetermined length, AP0 on RACH 151 to a BS and awaits reception of a response signal from the BS. If the MS fails to receive the response signal for a predetermined time period 156, tp-p, it retransmits a preamble 154, AP1 with a transmit power increased by AP with respect to the transmit power of AP0, considering that the BS has not detected the preamble AP0. Upon detection of preamble AP1 on the RACH 151, the BS sends a response signal 102 with a signature set in the received preamble AP1 on AP-AICH 101 to the MS.

In the mean time, the MS monitors reception of response signal 102 from the BS. Upon receipt of response signal 102 with the signature on AP-AICH 101 a time period 103, tp-ai later, the MS demodulates the signature. If received signal 102 is an ACKnowledgement (ACK), the MS sends a message 157 with the transmit power of the transmitted preamble AP1 on RACH 151 a predetermined time 158, ap-msg later, considering that the BS has detected preamble AP1.

FIG. 2 illustrates the structure of the preambles illustrated in FIG. 1.

Referring to FIG. 2, the MS sends a preamble using a selected signature without any control information. Each transmission of the preamble in an access attempt is called an access probe. Unless the MS receives on the AP-AICH a signal indicating that the BS has detected the access probe, it cannot send any message to the BS.

FIG. 3 is a diagram illustrating the transmission and reception timings of a RACH and a downlink channel under consideration in the 3^{rd} Generation Partnership Project Long-Term Evolution (3GPP LTE).

The 3GPP LTE system uses Orthogonal Frequency Division Multiplexing (OFDM) for the downlink, and Single Carrier-Frequency Division Multiple Access (SC-FDMA) for data transmission on the uplink. Therefore, the RACH is sent/received in a different manner than in the CDMA.

A signal flow of the RACH is made in the same manner in the 3GPP LTE system as in the WCDMA system. That is, an MS sends a preamble on the Random Access Channel (RACH). Upon detection of the preamble, a BS sends a response signal for the preamble on an Access Preamble-Acquisition Indication Channel (AP-AICH) and the MS then sends a data message. Notably, since 3GPP LTE physical channels are sent in a scheme other than CDMA, a corresponding efficient transmission scheme must be designed.

A RACH transmission scheme under discussion in the 3GPP LTE system is shown in FIG. 3. Referring to FIG. 3, the MS sends a preamble 352 of a predetermined length, AP0, on RACH 351 to the BS and awaits reception of a response signal from the BS. If the MS does not receive the response signal for a predetermined time period 356, tp-p, it retransmits preamble 353, AP1 with a transmit power increased by ΔP with respect to the transmit power of AP0, considering that the BS has not detected preamble AP0. This means that the MS has not detected its signature in a signal received on AP-AICH 301. This operation is repeated until the MS detects a response message 302 called an access grant message with the signature or the Identification (ID) of the MS within the predetermined time period tp-p.

Upon detection of preamble AP1, the BS sends access grant message 302 on AP-AICH 301.

In the mean time, the MS monitors reception of access grant message 302 for transmitted preamble AP1. Upon receipt of access grant message 302 with the signature set in preamble AP1 or the ID of the UE at time 303, tp-ai later, the MS sends an uplink common channel message 355 with the transmit power of the preamble AP1 in SC-FDMA after a predetermined time period 357, tp-msg. Message 355 is sent on a channel allocated by access grant message 302 by adjusting its transmission time according to control information included in time correction information set in access grant message 302.

At present, successive transmission of a preamble and a short control message on the RACH is under discussion in the 3GPP LTE.

FIG. 4 shows the components of a short control message on the RACH in the 3GPP LTE system.

Referring to FIG. 4, an access probe 401 includes a signature field 402 for carrying the signature of the MS according to its original usage and a message field 403 for delivering a short control message. An MS ID, buffer status information, service priority information, or downlink channel information may be included in the short control message. As is implied by its appellation, the short control message is relatively short, raging from a few bits to tens of bits. The BS uses signature 402 for channel estimation and message demodulation. Message 403 can be channel-encoded or iteratively encoded, prior to transmission. The transmission of the preamble and the short control message together can drop the collision probability of the RACH and increase the whole RACH throughput. Also, the MS can send a short message such as a channel request simultaneously along with the preamble, without an additional message transmission.

As illustrated in FIG. 4, a preamble and a short message are sent in time division. In other words, the preamble of a predetermined length is followed by the short message.

The above time division of signature field 402 and message field 403 on the RACH may lead to performance degradation. First of all, signature field 402 and message field 403 may be sent at different power levels for preamble acquisition and message demodulation, respectively, thus affecting cell coverage. To avert this problem, the same transmit power is applied to signature field 402 and message field 403 and their lengths are adjusted, to thereby achieve a desired performance. Yet, if signature field 402 is lengthened, the detection performance of signature field 402 is increased, but the channel decoding performance of message field 403 is kept unchanged. Therefore, the channel coding of the message limits the cell coverage. Alternatively if the coding rate of message field 403 is decreased to expand the cell coverage, the access probe becomes too long and message field 403 suffers from great channel variation during transmission. As a consequence, an inaccurate channel estimate is derived from signature field 402 and thus the message channel decoding performance is degraded. Thus it can be concluded that the conventional time-division transmission of signature field 402 and message field 403 has limitations in power allocation or length control.

Another drawback with the time-division transmission is that the channel estimation performance for a fast MS is degraded. If signature field 402 is positioned far from message field 403 in time, the performance is also degraded with respect to a fast Doppler frequency.

### SUMMARY OF THE INVENTION

An aspect of the present invention is to address at least the problems and/or disadvantages described above and to provide at least the advantages described below. Accordingly, an aspect of exemplary embodiments of the present invention is to provide an apparatus and method for transmitting a preamble and a short message simultaneously on a RACH in a CDMA or OFDMA communication system.

Another aspect of the present invention provides an apparatus and method for flexibly allocating transmits power to a preamble and a short message that are delivered on a RACH.

A further aspect of the present invention provides an apparatus and method for flexibly adjusting the lengths of a preamble and a message that are delivered on a RACH.

Still another aspect of the present invention provides an apparatus and method for simultaneously transmitting a preamble and a message on a RACH, while maintaining the Peak-to-Average Power Ratio (PAPR) low.

Yet another aspect of the present invention provides an apparatus and method for increasing the demodulation performance of a message sent simultaneously with a preamble on a RACH by facilitating channel estimation of the RACH.

In accordance with an aspect of the present invention, there is provided a method for transmitting a message on a RACH in a mobile communication system, in which a short message is generated to be sent together with a preamble signal on the RACH, for uplink transmission, the short message and the preamble signal are spread with different orthogonal spreading codes, the phase of the short message is rotated to be orthogonal to the phase of the preamble signal, the phase-rotated short message is added to the preamble signal, and the sum is sent.

In accordance with another aspect of the present invention, there is provided an apparatus for transmitting a message on a RACH in a mobile communication system, in which a message generator generates a short message to be sent together with a preamble signal on the RACH, for uplink transmission, a spreader spreads the short message and the preamble signal with different orthogonal spreading codes, a phase rotator rotates the phase of the short message to be orthogonal to the phase of the preamble signal, and a transmitter adds the phase-rotated short message to the preamble signal and sends the added signal.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating the transmission and reception timings of a downlink channel and an uplink common channel in a conventional asynchronous communication system;

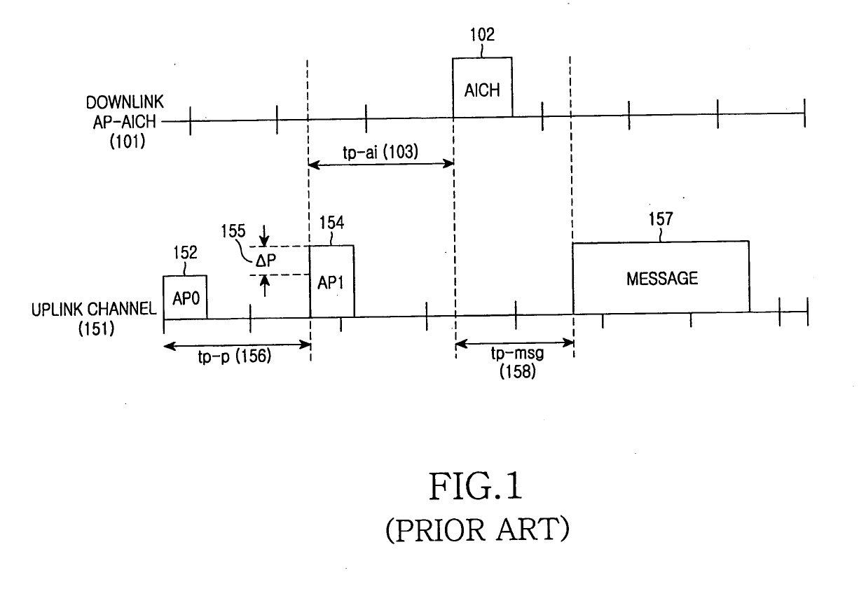

FIG. 2 illustrates a preamble structure in the conventional asynchronous communication system;

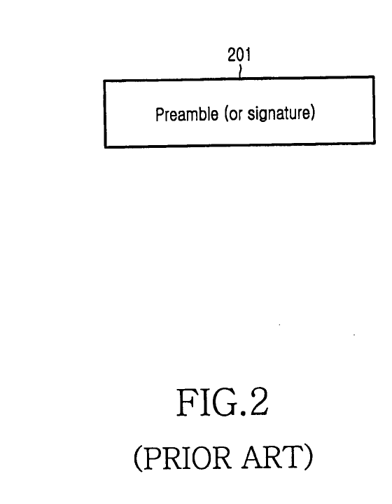

FIG. 3 is a diagram illustrating the transmission and reception timings of a downlink channel and a RACH under consideration in the 3GPP LTE;

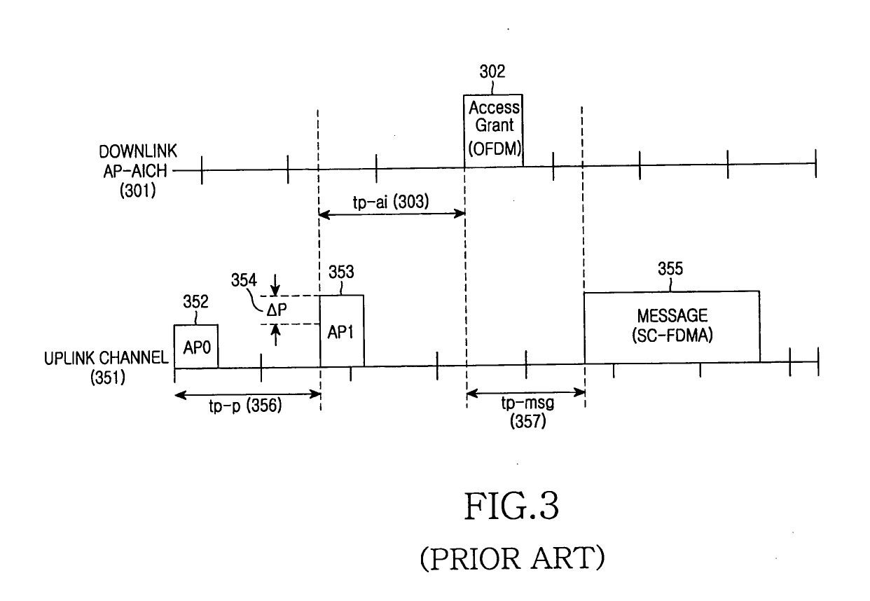

FIG. 4 shows the components of a short message with control information sent on the RACH in a 3GPP LTE communication system;

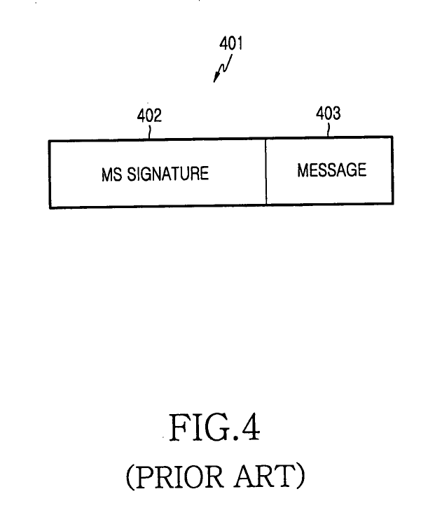

FIGS. 5A, 5B and 5C illustrate access probe structures according to the present invention;

FIG. 6A is a block diagram of an MS transmitter for sending an access probe having the configuration illustrated in FIG. 5A, 5B or 5C according to the present invention;

FIG. 6B is a block diagram of an MS transmitter for sending an access probe having the configuration illustrated in FIG. 5A, 5B or 5C according to the present invention;

FIG. 7 is a block diagram of a BS receiver for receiving an access probe from the MS transmitter according to the present invention;

FIG. 8 is a flowchart of an operation of the BS receiver according to the present invention;

FIG. 9 illustrates RACH allocation under consideration in the 3GPP LTE.

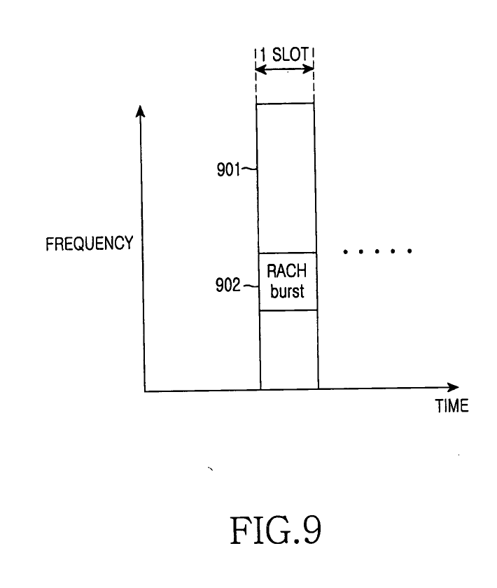

### DETAILED DESCRIPTION OF PREFERRED EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

To overcome the difficulty in flexible allocation of power transmission of a preamble and a message, which are sent conventionally in time division, exemplary embodiments of the present invention provide a method for sending a message containing control information together with a preamble or signature in code division on a RACH by an MS. A short control message including an MS ID, buffer status information, or service priority information alone or in combination is delivered in the message. That is, the MS includes a preamble or signature and a message in code division in an access probe. The message can be a short control message or a short data message.

It is assumed that the access grant message is a coded message sent in a predetermined time-frequency area. The access grant message may include time correction information of the RACH, the ID of the RACH, and information about an uplink channel allocated for data transmission from the MS. The access grant message can be sent on a channel other than an AP-AICH.

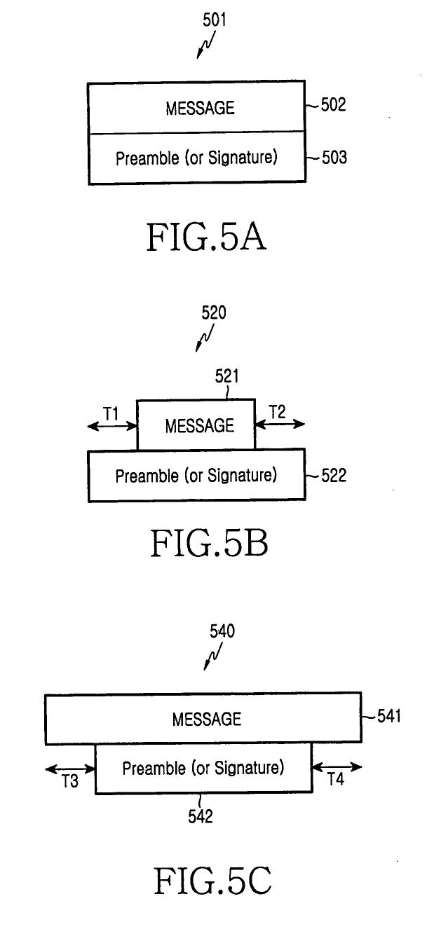

FIGS. 5A, 5B and 5C illustrate access probe structures according to an exemplary embodiment of the present invention. Referring to FIG. 5A, a message 502 with control information is as long as a signature 503. Referring to FIG. 5B, a signature 522 is longer than a message 521. An interval T1 between the start of message 521 and the start of signature 522 and an interval T2 between the end of message 521 and the end of signature 522 are system parameters broadcast on all MSs on a downlink broadcast channel. Referring to FIG. 5C, a message 541 is longer than a signature 542. An interval T3 between the start of signature 542 and the start of message 541 and an interval T4 between the end of the signature 542 and the end of the message 541 are system parameters broadcast on all MSs on the downlink broadcast channel.

The message and the preamble or signature are sent simultaneously in code division in the access probe and the length of the message is variable depending on system environment.

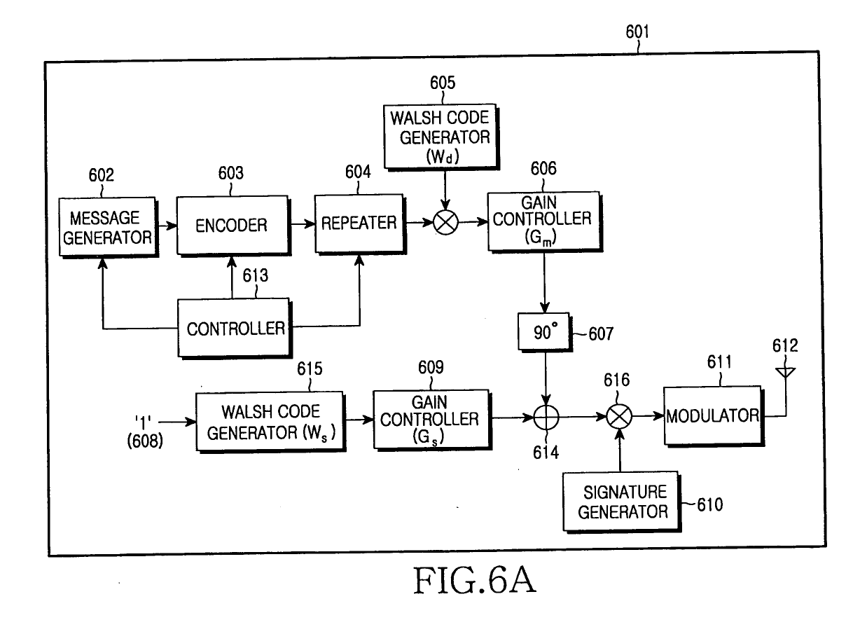

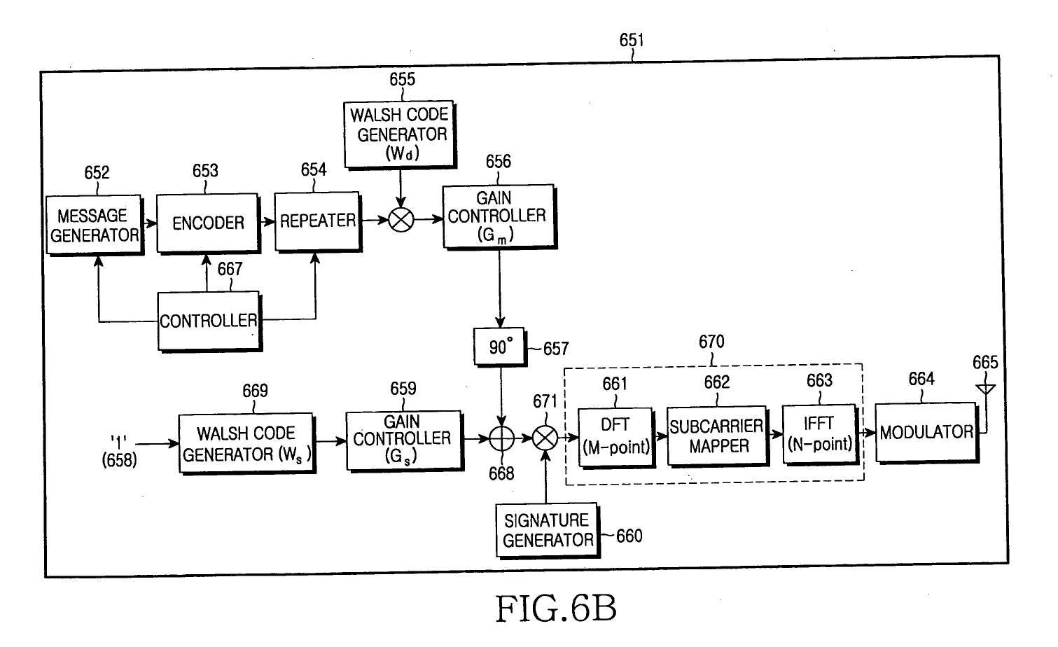

With reference to FIG. 6A, the configuration and operation of the MS transmitter will be described below.

Referring to FIG. 6A, a message generator 602 generates a message to be sent on the RACH. The message can be a short control message including MS ID information, buffer status information, or priority information of a service provided to an MS, alone or in combination. In the present invention, this message is sent together with a preamble or signature in an access probe.

In an exemplary embodiment of the present invention, the message and the preamble or signature are sent in code division. For the code division, orthogonal Walsh codes may be applied to the message and the preamble or signature. An encoder 603 encodes the message in a predetermined coding scheme such as convolutional coding. If the message includes only a few bits, it can be encoded by Hadamard coding. A repeater 604 repeats the coded data in a predetermined method, thus producing a symbol sequence with the intended length.

The preamble or signature is sent on an I axis and the message is sent on a Q axis in an exemplary embodiment of the present invention. Thus, the message is modulated in a modulation scheme using only the Q axis, like Binary Phase Shift Keying (BPSK). A preamble signal is always a constant, 1, before it is multiplied by a signature.

The repeated message is spread with a Walsh code W_{d} generated from a first Walsh code generator 605. A gain controller 606 multiplies the spread message by a gain needed for data transmission.

A controller 613 controls the start and end of the message according to the interval between the message and the signature, as illustrated in FIGS. 5A, 5B and 5C.

The preamble signal before being multiplied by the signature is sent on the I axis and the message is sent on the Q axis. Hence, a phase rotator 607 generates a Q-axis signal by rotating the message by 90 degrees. As stated above, the preamble signal is always 1 and multiplied by a Walsh code Wₛ generated from the second Walsh code generator 605. Walsh codes W_{d} and Wₛ are mutually orthogonal. Walsh code Wₛ can be W₀, i.e. 1. Walsh codes W_{d} and Wₛ can be system parameters sent to all MSs on the downlink broadcast channel, or generated using an MS ID or a selected signature for an access probe. Herein, it is assumed that Walsh codes W_{d} and Wₛ are broadcasted to all MSs on the downlink broadcast channel.

A gain controller 609 controls the gain of the preamble signal. The gain is variable according to an acquisition performance requirement of a BS. An adder 614 adds the gain-controlled preamble signal to the phase-rotated message. A multiplier 616 multiplies the sum by a signature generated from signature generator 610. The signature can be a complex sequence with I and Q components, to which the present invention is not limited. The signature may include an MS ID, as in WCDMA. If the MS ID cannot be delivered by the signature, like the extended MS ID, it can be carried in a short control message proposed by the present invention. The MS ID can be a unique number for the MS, a temporary Medium Access Control (MAC) ID allocated to the MS, or a temporary ID allocated to the MS during a random access, for avoiding collision with other MSs. A modulator 611 modulates the product received from multiplier 616 and sends the modulated signal through an antenna 612.

The MS transmitter has the configuration illustrated in FIG. 6A in the case where an access probe is sent in CDMA. If the access probe is sent in SC-FDMA, the MS transmitter can be configured as illustrated in FIG. 6B.

Referring to FIG. 6B, a message generator 652 generates a message to be sent on the RACH. The message can be a short control message including MS ID information, buffer status information, or priority information of a service provided to an MS, alone or in combination. In the present invention, this message is sent together with a preamble or signature in an access probe.

In an exemplary embodiment of the present invention, the message and the preamble or signature are sent in code division. For the code division, orthogonal Walsh codes may be used for the message and the preamble or signature. An encoder 653 encodes the message in a predetermined coding scheme such as convolutional coding. If the message includes only a few bits, it can be encoded by Hadamard coding. A repeater 654 repeats the coded data in a predetermined method, thus producing a symbol sequence of an intended length.

The preamble or signature is sent on an I axis and the message is sent on a Q axis in an exemplary embodiment of the present invention. Thus, the message is modulated in a modulation scheme using only the Q axis, like BPSK. A preamble signal is always a constant, 1, before it is multiplied by a signature.

The repeated message is spread with a Walsh code W_{d} generated from a first Walsh code generator 655. A gain controller 656 multiplies the spread message by a gain needed for data transmission. A controller 667 controls the start and end of the message according to the intervals between the message and the signature, as illustrated in FIGS. 5A, 5B and 5C.

The preamble signal before being multiplied by the signature is sent on the I axis and the message is sent on the Q axis. A phase rotator 657 generates a Q-axis signal by rotating the message by 90 degrees. As stated above, the preamble signal is always 1 and multiplied by a Walsh code Wₛ generated from a second Walsh code generator 669. Walsh codes W_{d} and Wₛ are mutually orthogonal. Walsh code Wₛ can be W₀, i.e. 1. Walsh codes W_{d} and Wₛ can be system parameters sent to all MSs on the downlink broadcast channel, or generated using an ID of the MS or a selected random access signature. It is assumed that Walsh codes W_{d} and Wₛ are broadcast to all MSs on the downlink broadcast channel.

A gain controller 659 controls the gain of the preamble signal. The gain is variable according to an acquisition performance requirement of a BS. An adder 668 adds the gain-controlled preamble signal to the message received from phase rotator 607. A multiplier 671 multiplies the sum by a signature generated from signature generator 660. The signature can be a complex sequence with I and Q components, to which the present invention is not limited. The signature may include an ID of the MS, as in WCDMA. If the MS ID cannot be delivered by the signature, like the extended MS ID, it can be carried in the short control message provided by the present invention. The MS ID can be a unique number for the MS, a temporary MAC ID allocated to the MS, or a temporary ID allocated to the MS during a random access, for avoiding collision with other MSs.

Reference numeral 670 denotes an SC-FDMA generator for generating an SC-FDMA signal.

In the SC-FDMA generator 670, an M-point Discrete Fourier Transform (DFT) processor 661 calculates M frequency components by transforming M input samples. A subcarrier mapper 662 maps the M signals to subcarriers in a predetermined method and allocates 0s to non-mapped subcarriers. The subcarriers can be mapped across a total frequency band in a distributed fashion, around predetermined subcarriers in a localized manner, or in both. The present invention assumes the localized subcarrier mapping.

An N-point Inverse Fast Fourier Transform (IFFT) processor 663 converts N samples received from subcarrier mapper 662 to a time-domain signal. A modulator 664 modulates the time-domain signal and sends the modulated signal through an antenna 665. DFT processor 661 may be replaced with a Fast Fourier Transform (FFT) processor.

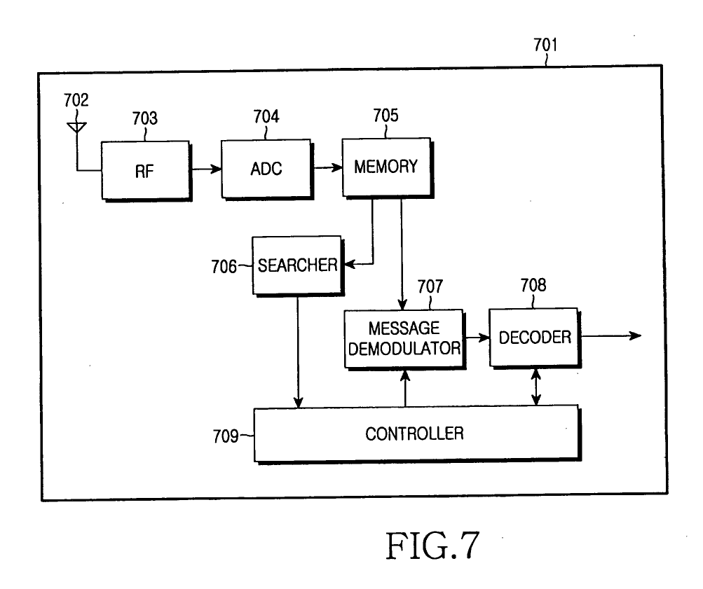

Referring to FIG. 7, a Radio Frequency (RF) processor 703 downconverts the RF signal received through antenna 702 to a baseband signal. Analog-to-Digital Converter (ADC) 704 converts the baseband analog signal to a baseband digital signal through sampling. Memory 705 stores the baseband samples for an RACH slot length or longer. Searcher 706 searches for the starts of all available preambles or signatures from the stored samples. In the present invention, it is assumed that searcher 706 uses a correlator and provides the search result including a correlation, the detected position of the correlation, and a preamble or signature corresponding to correlation to a controller 709.

Controller 709 provides overall control to the BS receiver. It also determines from the search result whether a preamble or signature has been detected. If the correlation indicated by the search result is lower than the threshold, controller 709 determines that a preamble has not been received. If the correlation exceeds the threshold, controller 709 determines that a preamble has been received and controls decoding of a message received together with the preamble. Controller 709 calculates the start and end of the message from the search result and controls a demodulator 707 and a decoder 708 based on the calculation. The start and end of the message are calculated according to an access probe structure used in the system, as illustrated in FIG. 5A, 5B or 5C. In case of the access probe structure illustrated in FIG. 5A, the message starts and ends at the same time with the preamble or signature. In case of the access probe structure illustrated in FIG. 5B, the message starts T1 later than the preamble or signature and ends T2 earlier than the preamble or signature. In case of the access probe structure illustrated in FIG. 5C, the message starts T3 earlier than the preamble or signature and ends T4 later than the preamble or signature.

A message demodulator 707 decodes a channel-coded message and outputs a symbol-level soft metric. If the MS transmitter repeated the message, the symbol-level soft metric is accumulated. Decoder 708 decodes the demodulated signal and provides the decoded signal to controller 709. Controller 709 analyzes the decoded signal and performs an operation corresponding to the signal received on the RACH. If the message was convolutionally encoded, decoder 708 decodes the demodulated signal in accordance with the convolutional coding scheme. In this case, the channel decoding can be performed using a Viterbi decoding algorithm.

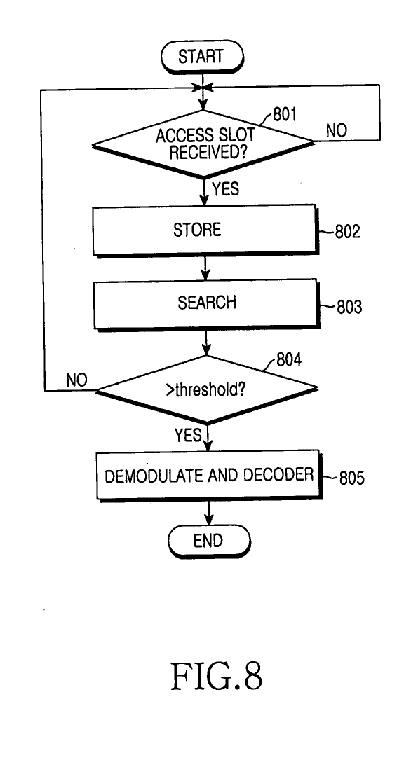

Referring to FIG. 8, a BS 701 monitors the start of an access slot in step 801. BS 701 loops in step 801 until the access slot starts. Upon detection of a RACH slot received from the MS, BS 701 stores the output of the ADC 704 in memory 705 in step 802. The length of the stored samples may be equal to or larger than an access slot length.

When the samples are completely stored in memory 705, BS 701 searches over all available preambles or signatures through searcher 706 in step 803. In the present invention, it is assumed that the search is carried out using a correlator. BS 701 then compares every correlation calculated by searcher 706 with a threshold in step 804. In the absence of any correlation exceeding the threshold, BS 701 returns to step 801 and waits for the next access slot.

In the presence of a correlation exceeding the threshold, BS 701 demodulates and decodes a message received together with a preamble or signature corresponding to the correlation in step 805.

As described above, the present invention provides a method for effectively transmitting a message together with a preamble or signature on a RACH. Thus, transmit power can be flexibly allocated to the preamble or signature and the message and also, their lengths can be flexibly controlled. Furthermore, the PAPR of the RACH can be effectively decreased.

While the invention has been shown and described with reference to certain exemplary embodiments thereof, it will be understood by those skilled in the art that various changes in form and details may be made therein without departing from the spirit and scope of the present invention as further defined by the appended claims and their equivalents.

What is claimed is:

1. A method for transmitting a message on an uplink Random Access Channel (RACH) in a mobile communication system, comprising:
generating a short message to be sent together with a preamble signal on the RACH, for uplink transmission;
spreading the short message and the preamble signal with different orthogonal spreading codes;
sending the short message and the preamble message together.

2. The method of claim 1, further comprising rotating the phase of the short message to be orthogonal to the phase of the preamble signal before sending the short message and the preamble signal.

3. The method of claim 1, wherein the short message and the preamble signal are equal in length.

4. The method of claim 1, wherein the short message is shorter than the preamble signal.

5. The method of claim 4, further comprising sending the short message later than the start of the preamble signal.

6. The method of claim 4, further comprising completing transmission of the short message earlier than the end of the preamble signal.

7. The method of claim 1, wherein the preamble signal is shorter than short message.

8. The method of claim 7, further comprising sending the preamble signal later than the start of short message.

9. The method of claim 7, further comprising completing transmission of the preamble signal earlier than the end of the short message.

10. An apparatus for transmitting a message on an uplink Random Access Channel (RACH) in a mobile communication system, comprising:
a message generator for generating a short message to be sent together with a preamble signal on the RACH, for uplink transmission;
a spreader for spreading the short message and the preamble signal with different orthogonal spreading codes;
a transmitter for transmitting the short message and the preamble signal together.

11. The apparatus of claim 10, further comprising:
a phase rotator for rotating the phase of the short message to be orthogonal to the phase of the preamble signal before transmitting the short message and the preamble signal.

12. The apparatus of claim 10, wherein the short message is equal to the preamble signal in length.

13. The apparatus of claim 10, wherein the short message is shorter than the preamble signal.

14. The apparatus of claim 13 wherein the transmitter sends the short message later than the start of the preamble signal.

15. The apparatus of claim 13, wherein the transmitter completes transmission of the short message earlier than the end of the preamble signal.

16. The apparatus of claim 10, wherein the preamble signal is shorter than the short message.

17. The apparatus of claim 16, wherein the transmitter sends the preamble signal later than the start of the short message.

18. The apparatus of claim 16, wherein the transmitter completes transmission of the preamble signal earlier than the end of the short message.

19. The apparatus of claim 10, wherein the transmitter sends the added signal by Orthogonal Frequency Division Multiplexing (OFDM) modulation.

20. A method for receiving a message on an uplink Random Access Channel (RACH) in a mobile communication system, comprising:
receiving a message and a preamble signal simultaneously on the RACH, converting the received message and preamble signal to a digital signal, and storing the digital signal;
detecting a transmission signal from the preamble signal; and
demodulating and decoding the message, when the transmission signal is detected.

21. The method of claim 20, wherein the detection comprises detecting the transmission signal using correlations with all available transmission signals.

22. An apparatus for receiving a message on an uplink Random Access Channel (RACH) in a mobile communication system, comprising:
a receiver for receiving a message and a preamble signal simultaneously on the RACH, converting the received message and preamble signal to a digital signal, and storing the digital signal;
a searcher for detecting a transmission signal from the preamble signal and outputting a detection signal;
a controller for controlling demodulation and decoding of the message according to the detection signal; and
a modem for demodulating and decoding the message under the control of the controller.

23. The apparatus of claim 22, wherein the searcher comprises a correlator and the controller controls the correlator to calculate correlations with all available transmission signals, for detection of the transmission signal.
